(19) United States
(12) Patent Application Publication
(10) Pub. No.: US 2026/0247348 A1
(43) Pub. Date: Aug. 20, 2026

(54) METHOD FOR WIRELESS BRIDGING AND WIRELESS BRIDGE DEVICE

(71) Applicant: TP-Link Systems Inc., IRVINE, CA (US)

(72) Inventor: Suixin Ou, Shenzhen (CN)

(73) Assignee: TP-Link Systems Inc., IRVINE, CA (US)

(21) Appl. No.: 19/055,019

(22) Filed: Feb. 17, 2025

(51) Int. Cl. H04W 72/02; H04W 72/0453; H04W 72/51; H04W 72/541

(52) U.S. Cl. CPC H04W 72/02; H04W 72/0453; H04W 72/51; H04W 72/541

(57) ABSTRACT

The present disclosure provides a method for wireless bridging. The method may include: determining a first score for each of at least one available frequency band supported by a wireless bridge device based on a first status information of the wireless bridge device and a second status information of a wireless access device; and selecting, one or more of the at least one available frequency band to bridge with the wireless access device based on a first capability information of the wireless bridge device, a second capability information of the wireless access device, and the first score for each of the at least one available frequency band.

### TECHNICAL FIELD

The present disclosure relates to a method for wireless bridging, a wireless bridge device used to perform the method and a wireless bridging system including the wireless bridge device and a wireless access device.

### BACKGROUND

In large campus or office environments, multiple wireless access points are typically deployed and connected via wired links to switches and gateways, forming an intranet or accessing the core network to achieve wider wireless coverage. In large campuses where the distance between buildings can exceed hundreds of meters, optical cables are often required for wired connections. This can be costly, especially in established campuses, where laying new cables may require digging up roads. In addition, for temporary network transmission needs, such as outdoor live broadcasts, wired deployment on-site can be time-consuming, labor-intensive, and challenging to maintain and manage. A method that can automatically wirelessly establish a network is desired.

### SUMMARY

According to one embodiment of the present disclosure, there is provided a method for wireless bridging. The method may comprise: determining, a first score for each of at least one available frequency band supported by a wireless bridge device based on a first status information of the wireless bridge device and a second status information of a wireless access device; and selecting one or more of the at least one available frequency band to bridge with the wireless access device based on a first capability information of the wireless bridge device, a second capability information of the wireless access device, and the first score for each of the at least one available frequency band.

According to another embodiment of the present disclosure, there is provided a wireless bridge device. The wireless bridge device may comprise: one or more memories, storing computer readable instructions; one or more processors, coupled with the one or more memories that, when the computer readable instructions executed by the one or more processors, cause the one or more processors to: determine, a first score for each of at least one available frequency band supported by a wireless bridge device based on a first status information of the wireless bridge device and a second status information of a wireless access device; and select, one or more of the at least one available frequency band to bridge with the wireless access device based on a first capability information of the wireless bridge device, a second capability information of the wireless access device, and the first score for each of the at least one available frequency band.

According to another embodiment of the present disclosure, there is provided a wireless bridge system. The wireless bridge system comprises the above wireless bridge device and a wireless access device. The wireless bridge device may comprise: one or more memories, storing computer readable instructions; one or more processors, coupled with the one or more memories that, when the computer readable instructions executed by the one or more processors, cause the one or more processors to: determine, a first score for each of at least one available frequency band supported by a wireless bridge device based on a first status information of the wireless bridge device and a second status information of a wireless access device; and select, one or more of the at least one available frequency band to bridge with the wireless access device based on a first capability information of the wireless bridge device , a second capability information of the wireless access device, and the first score for each of the at least one available frequency band. The wireless access device is configured to broadcast the second capability information and the second status information to the wireless bridge device.

According to a yet another embodiment of the present disclosure, there is provided a computer program product for wireless bridging. The computer program product comprises a non-transitory computer readable storage medium having program instructions embodied therewith, the program instructions executable by a processor to cause the processor to: determine, a first score for each of at least one available frequency band supported by a wireless bridge device based on a first status information of the wireless bridge device and a second status information of a wireless access device; and select, one or more of the at least one available frequency band to bridge with the wireless access device based on a first capability information of the wireless bridge device, a second capability information of the wireless access device, and the first score for each of the at least one available frequency band.

At least based on the above embodiments of the present disclosure, an improved technique for wireless bridging and wireless networking may be realized. This technique enables the automatically selection of frequency band(s) for bridging between the wireless bridge device and the wireless access device, thereby automatically achieving wirelessly networking.

### BRIEF DESCRIPTION OF DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure but do not constitute a limitation on the present disclosure. In the drawings, unless otherwise explicitly indicated, the same reference numerals refer to the same components, steps or elements.

FIG. 1 is a diagram illustrating an exemplary architecture of a wireless bridge system according to at least one embodiment of the present disclosure;

FIG. 2 is an exemplary flowchart illustrating the method for wireless bridging according to at least one embodiment of this disclosure;

FIG. 3 is an exemplary flowchart illustrating the step S220 in FIG. 2;

FIG. 4 is an exemplary flowchart illustrating the method for wireless bridging according to at least one embodiment of the present application;

FIG. 5 is an exemplary flowchart illustrating the method for wireless bridging according to at least one embodiment of the present application;

FIG. 6 is an exemplary flowchart illustrating the method for wireless bridging according to at least one embodiment of the present application;

FIG. 7 is an exemplary flowchart illustrating the method for wireless bridging according to at least one embodiment of the present application; and

FIG. 8 is an exemplary block diagram illustrating a wireless bridge device according to at least one embodiment of the present application.

### DETAILED DESCRIPTION

The technical solution of the present disclosure will be clearly and completely described below in conjunction with accompanying drawings. The described embodiments are part of embodiments of the present disclosure, but not all of them. Based on the embodiments in the present disclosure, all other embodiments acquired by ordinary skilled in the art without making any creative efforts fall within the scope of protection of the present disclosure.

In the description of the present disclosure, it should be noted that orientations or positional relationships indicated by terms such as "center", "upper", "lower", "left", "right", "vertical", "horizontal", "inside" and "outside" are based on orientations or positional relationships shown in the drawings, only for the convenience of describing the present disclosure and simplifying the description, instead of indicating or implying the indicated device or element must have a particular orientation. In addition, terms such as "first", "second" and "third" are only for descriptive purposes, whereas cannot be understood as indicating or implying relative importance. Likewise, words like "a", "an" or "the" do not represent a quantity limit but represent an existence of at least one. Words like "include" or "comprise" mean that an element or an object in front of the said word encompasses those ones listed following the said word and their equivalents, without excluding other elements or objects. Words like "connect" or "link" are not limited to physical or mechanical connections, but may include electrical connections, whether direct or indirect.

In the description of the present disclosure, it should be noted that, unless otherwise explicitly specified and limited, terms such as "mount", "link" and "connect" should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the specific meanings of the above terms in the present disclosure may be understood on a case-by-case basis.

In addition, technical features involved in different embodiments of the present disclosure described below may be combined as long as no conflicts occur therebetween.

Some of the drawings may not depict all the components of a given method, device and system. Like reference numerals may be used to denote like features throughout the specification and drawings.

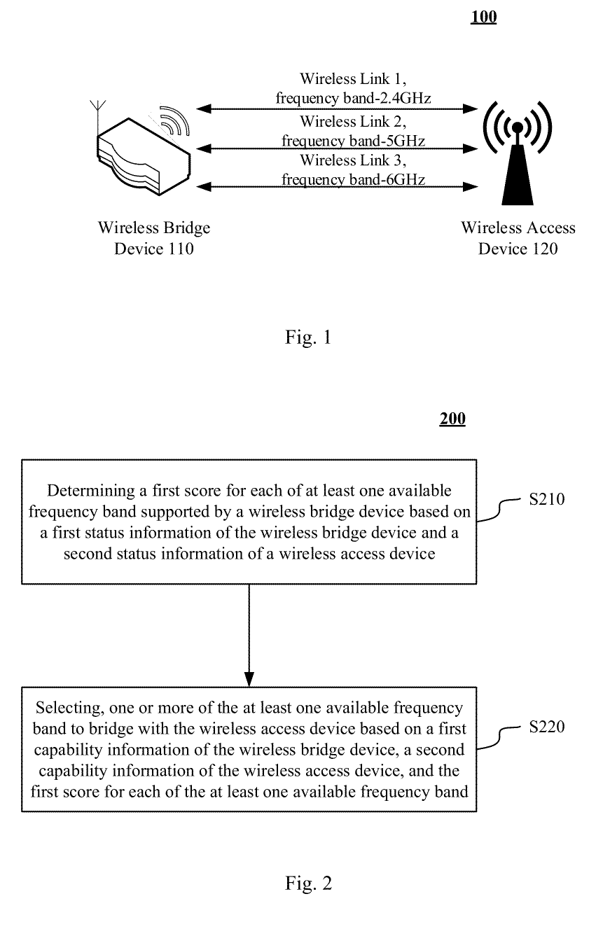

FIG. 1 is a diagram illustrating an exemplary architecture of the wireless bridge system according to at least one embodiment of the present disclosure.

As shown in FIG. 1, the wireless bridge system 100 according to an embodiment of the present disclosure may include a wireless bridge device 110 and a wireless access device 120. The wireless access device 120 may be a wireless access point configured in “access point mode” and serve as a primary connection point to the network, enabling the terminal devices (such as phones and computers) to connect to the network. The wireless bridge device 110 may be a wireless access point configured in “bridge mode” and act as a bridge, typically connecting to other wireless bridge device(s) or other wireless access device(s) to extend the network reach. It should be noted that in FIG. 1, one wireless bridge device and one wireless access device are shown only for convenience of describing the present disclosure and simplifying the description, the wireless bridge system 100 may include multiple wireless bridge devices and multiple wireless access devices.

Depending on whether the wireless bridge device 110 and the wireless access device 120 support a single-frequency band mode or a multi-frequency bands mode, the wireless bridge device 110 may bridge with the wireless access device 120 on a signal frequency band or on multiple frequency bands. The multi-frequency bands mode allows simultaneous data transmission and reception across multiple frequency bands, such as two or more of 2.4GHz, 5GHz, and 6GHz. The single-frequency band mode allows data to be transmitted and received on a single frequency band only, such as one of 2.4GHz, 5GHz, or 6GHz. That is, the wireless bridge device 110 may establish one or more wireless links with the wireless access device 120 if both the wireless bridge device 110 and the wireless access device 120 support the multi-frequency bands mode, and may establish only one wireless link with the wireless access device 120 if not so.

FIG. 2 is an exemplary flowchart illustrating the method for wireless bridging according to at least one embodiment of this disclosure.

Referring to FIG. 2, the method 200 for wireless bridging may include steps S210 and S220.

As shown in FIG. 1, the wireless bridge device 110 may obtain the first capability information and the first status information of itself. For example, the first capability information and the first status information may be read from the firmware (such as the Wi-Fi wireless chip) or software system of the wireless bridge device 110. The first capability information of the wireless bridge device 110 may indicate whether the wireless bridge device 110 supports the signal-frequency band mode or the multi-frequency bands mode, the operation channel number corresponding to each supported frequency band, and the operation bandwidth, etc. of the wireless bridge device 110. The first status information of the wireless bridge device 110 may indicate at least one of the following parameters of wireless bridge device 110: the interference strength, channel utilization, signal strength, transmission rate, transmission delay and throughput, etc.

Initially, the wireless bridge device 110 is not bridged with the wireless access device 120. The wireless bridge device 110 may receive a broadcast frame from the wireless access device 120. For example, the broadcast frame may be a beacon frame periodically broadcast by the wireless access device 120. The broadcast frame may include the second capability information and the second status information of the wireless access device 120. The second capability information of the wireless access device 120 may indicate whether the wireless access device 120 supports the signal-frequency band mode or the multi-frequency bands mode, the operation channel number corresponding to each supported frequency band, and the operation bandwidth, etc. of the wireless access device 120. The second status information of the wireless access device 120 may indicate the at least one of the parameters of the wireless access device 120: interference strength, channel utilization, signal strength, transmission rate, transmission delay and throughput, etc.

At the step S210, the wireless bridge device 110 may determine a first score for each of at least one available frequency band supported by a wireless bridge device 110 based on a first status information of the wireless bridge device 110 and a second status information of the wireless access device 120. The first score for a particular frequency band may be indicative of the communication quality of the frequency band.

In this step, for each supported available frequency band, the wireless bridge device 110 may determine the first score by calculating the weighted sum of a set of parameters for the first and second status information. The set of parameters depends on the specific network environment and application requirements.

For example, in a network environment where the interference strength is critical, the first status information may comprise at least the interference strength of the wireless bridge device 110 and the second status information may comprise at least the interference strength of the wireless access device 120. For each of the at least one available frequency bands, the wireless bridge device 110 may determine the first score of the frequency band as the minimum value of the value range of the first score if the interference strength of the wireless bridge device 110 is greater than an interference strength threshold or the interference strength of the wireless access device 120 is greater than the interference strength threshold. Otherwise, the wireless bridge device 110 may determine the first score of the frequency band by calculating the weighted sum of the interference strength and one or more of the channel utilization, signal strength, transmission rate, transmission delay and throughput, etc. in the first and second status information.

For another example, in a network environment where the channel utilization is critical, the first status information may comprise at least the channel utilization of the wireless bridge device 110 and the second status information may comprise at least the channel utilization of the wireless access device 120. For each of the at least one available frequency band, the wireless bridge device 110 may determine the first score of the frequency band as the minimum value of the value range of the first score if the channel utilization of the wireless bridge device 110 is greater than a channel utilization threshold or the channel utilization of the wireless access device 120 is greater than the channel utilization threshold. Otherwise, the wireless bridge device 110 may determine the first score of the frequency band by calculating the weighted sum of the channel utilization and one or more of the interference strength, the signal strength, the transmission rate, the transmission delay and the throughput, etc. in the first and second status information.

For the sake of brevity, the various possible sets of parameters used for determining the first score are not enumerated here.

At the step S220, the wireless bridge device 110 may select one or more of the at least one available frequency band to bridge with the wireless access device 120 based on a first capability information of the wireless bridge device 110, a second capability information of the wireless access device 120, and the first score for each of the at least one available frequency band.

Thus, the method 200 for wireless bridging enables the wireless bridge device 110 to automatically select one or more frequency bands to bridge with the wireless access device 120, thereby automatically achieving wireless networking. In addition, by scoring each of the available frequency bands to select the optimal frequency band for bridging, the bridged wireless link(s) may be ensured to meet the communication requirements.

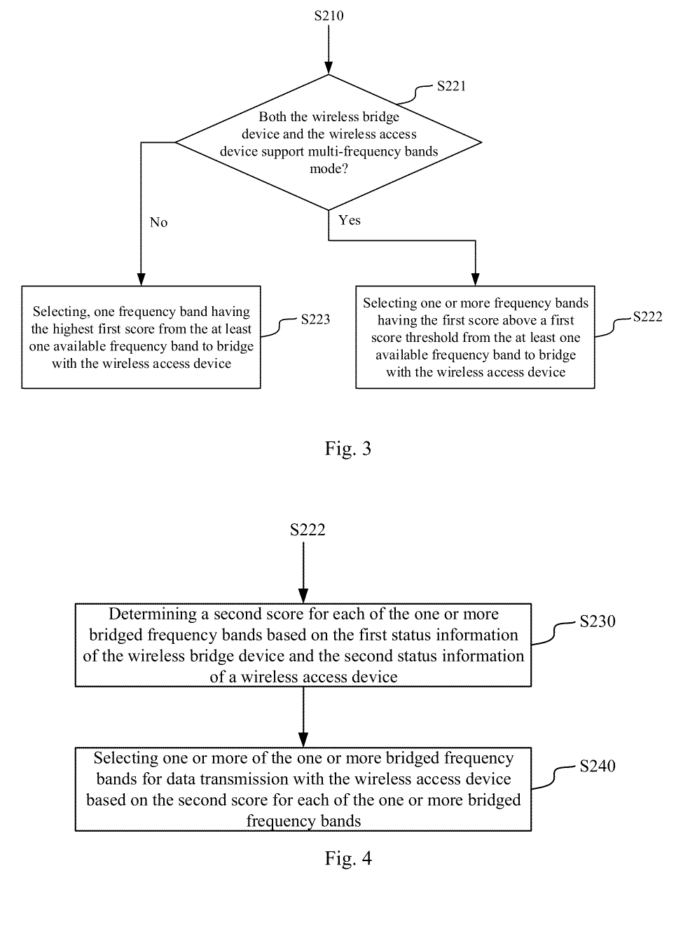

FIG. 3 is an exemplary flowchart illustrating the step S220 in FIG. 2.

Referring to FIG. 3, the step S220 in FIG. 2 may include steps S221 to S223.

At step S221, the wireless bridge device 110 may determine whether both the wireless bridge device 110 and the wireless access device 120 support the multi-frequency bands mode. In this step, the wireless bridge device 110 may determine whether it supports multi-frequency bands mode according to the first capability information of the wireless bridge device 110 and determine whether the wireless access device 120 supports the multi-frequency bands mode according to the second capability information of the wireless access device 120.

If it is determined in step S221 that the both the wireless bridge device 110 and the wireless access device 120 support multi-frequency bands mode, the method 200 may proceed to step S222. In one example, at step S222, the wireless bridge device 110 may select one or more frequency bands having the first score above a first score threshold from the at least one available frequency band to bridge with the wireless access device 120. In another example, at step S222, the wireless bridge device 110 may select the top one or more frequency bands from the at least one available frequency bands ranked in descending order of their first scores. If none of the first scores of the at least one available frequency bands are above the first score threshold, the wireless bridge device 110 may randomly select one or more frequency bands to bridge with other wireless access device(s) 120.

For example, the first capability information of the wireless bridge device 110 indicates that it supports simultaneous data transmission and reception across one or more of the frequency bands 2.4GHz, 5GHz, and 6GHz, and the second capability information of the wireless access device 120 also indicates that it supports simultaneous data transmission and reception across one or more of the frequency bands 2.4GHz, 5GHz, and 6GHz. In the step S221, it may be determined that both the wireless bridge device 110 and the wireless access device 120 support the multi-frequency bands mode. Given that the value range of the first score is [0, 1], the value of the first score threshold is 0.5. In an example, the first scores of the three frequency bands 2.4GHz, 5GHz, and 6GHz determined in step S201 are 0.5, 0.7 and 0.8, respectively, the wireless bridge device 110 may select all the three frequency bands 2.4GHz, 5GHz, and 6GHz to bridge with the wireless access device 120 in step S220. After bridging with the wireless access device 120, the wireless links 1, 2 and 3 shown in FIG. 1 are established between the wireless bridge device 110 and the wireless access device 120. The wireless bridge device 110 may use all of the wireless links 1, 2 and 3 or one or two of them at random for data transmission with the wireless access device 120. In another example, if the first scores of the three frequency bands 2.4GHz, 5GHz, and 6GHz determined in step S201 are 0.4, 0.7 and 0.8, respectively, the wireless bridge device 110 may select 5GHz and 6GHz to bridge with the wireless access device 120 in step S220. After bridging with the wireless access device 120, the wireless links 2 and 3 shown in FIG. 1 are established between the wireless bridge device 110 and the wireless access device 120. The wireless bridge device 110 may use the wireless links 2 and 3 or one of them at random for data transmission with the wireless access device 120. In another example, if the first scores of the three frequency bands 2.4GHz, 5GHz, and 6GHz determined in step S201 are 0.4, 0.3 and 0.8, respectively, the wireless bridge device 110 may select only 6GHz to bridge with the wireless access device 120 in step S220. After bridging with the wireless access device 120, the wireless link 3 shown in FIG. 1 is established between the wireless bridge device 110 and the wireless access device 120. The wireless bridge device 110 may use the wireless link 3 for data transmission with the wireless access device 120.

If it is determined in step S221 that the wireless bridge device 110 and/or the wireless access device 120 do not support multi-frequency bands mode, the method 200 may proceed to step S223. At step S223, the wireless bridge device 110 may select one frequency band with the highest first score from the at least one available frequency band to bridge with the wireless access device 120.

For example, the first capability information of the wireless bridge device 110 indicates that it supports simultaneous data transmission and reception across one or more of the frequency bands 2.4GHz, 5GHz, and 6GHz, but the second capability information of the wireless access device 120 indicates that it only supports data transmission and reception on only one of the frequency bands 2.4GHz, 5GHz, and 6GHz. Given the first scores of the three frequency bands 2.4GHz, 5GHz, and 6GHz determined in step S201 are 0.4, 0.3 and 0.8, respectively, the wireless bridge device 110 may select the frequency band 6GHz having the highest first score 0.8 to bridge with the wireless access device 120 in step S220. After bridging with the wireless access device 120, only the wireless link 3 shown in FIG. 1 is established between the wireless bridge device 110 and the wireless access device 120. The wireless bridge device 110 may use the wireless link 3 for data transmission with the wireless access device 120.

Thus, in the event that both the wireless bridge device 110 and the wireless access device 120 support the multi-frequency bands mode, the wireless bridge device 110 may select one or more frequency bands that meet the connectivity requirements (i.e., indicated by the first score threshold) to bridge with the wireless access device 120. In the event that the wireless bridge device 110 and/or the wireless access device 120 does not support the multi -frequency bands mode, the wireless bridge device 110 may select the frequency band with the best connectivity to bridge with the wireless access device 120. In this way, compatibility between the multi-frequency bands mode and the single-frequency band may be provided, allowing the wireless bridge device 110 and the wireless access device 120 with different frequency band support capability to achieve the best possible connection, providing strong adaptability and compatibility.

FIG. 4 is an exemplary flowchart illustrating the method for wireless bridging according to at least one embodiment of the present application.

Preferably, in the embodiment where both the wireless bridge device 110 and the wireless access device 120 support multi-frequency bands mode, after selecting one or more frequency bands with the first score above a first score threshold from the at least one available frequency band to bridge with the wireless access device 120 in step S222, the method 200 may further include steps S230 and S240 instead of randomly using the bridged one or more wireless links for data transmission, thereby optimizing bandwidth usage, reducing latency and improving reliability.

As shown in FIG. 4, at step S230, the wireless bridge device 110 may further determine a second score for each of the bridged two or more frequency bands based on the first status information of the wireless bridge device 110 and the second status information of a wireless access device 120. At step S240, the wireless bridge device 110 may select one or more of the bridged one or more frequency bands for data transmission with the wireless access device 120 based on the second score for each of the bridged one or more frequency bands.

In an embodiment where the network environment is stable with minimal fluctuations and factors affecting connectivity and data transmission quality are generally consistent for each of the bridged frequency bands, the wireless bridge device 110 may determine the second score for each of the bridged frequency bands using the same set of parameters as that used to calculate the first score for respective frequency band at the step S230. In a special example, in order to simplify the calculation of the second score for each of the bridged frequency bands as much as possible, the second score may be determined to be the same as the first score for the respective frequency band. In this case, the second score threshold used for selecting frequency bands for data transmission should be greater than the first score threshold used for selecting frequency bands for bridging.

For example, continuing with the previous example where the wireless bridge device 110 and the wireless access device 110 have bridged with each other over the frequency bands 2.4GHz, 5GHz, and 6GHz, if the network environment is stable, the second score for the bridged frequency bands 2.4GHz, 5GHz, and 6GHz may simply be determined to be the same as the first score thereof, i.e., 0.5, 0.7 and 0.8 for the frequency bands 2.4GHz, 5GHz, and 6GHz, respectively.

In another embodiment where the network environment fluctuates significantly and factors affecting connectivity and data transmission quality are significantly different for each of the bridged frequency bands, the wireless bridge device 110 may determine the second score for each of the bridged frequency bands using the set of parameters that is different from that used to determine the first score of the respective frequency band.

For example, also continuing with the previous example where the wireless bridge device 110 and the wireless access device 110 have bridged with each other over the frequency bands 2.4GHz, 5GHz, and 6GHz, if the network environment fluctuates significantly, the transmission rate, transmission delay and throughput of the wireless access device 120 may be crucial for the assess of the quality of the data transmission for the bridged frequency bands. Accordingly, the second score for each of the bridged frequency bands 2.4GHz, 5GHz and 6GHz may be determined by calculating the weighted sum of the interference strength, the channel utilization, the signal strength of the wireless bridge device 110 and the interference strength, the channel utilization, the signal strength, the transmission rate, the transmission delay and the throughput of the wireless access device 120. In this case, the second score for a bridged frequency band is independent of the first score of that bridged frequency band. As an example, the value range of the second score is also [0, 1], the second scores for the bridged frequency bands 2.4GHz, 5GHz and 6GHz are determined as 0.7, 0.8, 0.9, respectively.

In one example, at step S240, the wireless bridge device 110 may select the top at least one bridged frequency bands from the one or more bridged frequency bands ranked in descending order of their second scores for data transmission with the wireless access device 120.

In another example, at step S240, the wireless bridge device 110 may select at least one bridged frequency band having the second score above a second score threshold from the one or more bridged frequency bands for data transmission with the wireless access device 120, or select the top at least one of the one or more bridged frequency bands ranked in descending order of their second scores if none of the second scores of the one or more bridged frequency bands is above the second score threshold.

For example, continuing with the previous example where the wireless bridge device 110 and the wireless access device 120 have bridged with each other over the frequency bands 2.4GHz, 5GHz, and 6GHz and the second score for the bridged frequency bands 2.4GHz, 5GHz, and 6GHz are simply determined to be the same as the first score thereof, i.e., 0.5, 0.7 and 0.8 for the frequency bands 5GHz, and 6GHz, respectively. Given the second score threshold is 0.7, which is greater than the first score threshold of 0.5, the wireless bridge device 110 may select the 5GHz and 6GHz for data transmission with the wireless access device 120.

As a variant, if the computing capability of the wireless bridge device 110 are sufficient, step S230 may be omitted and the first score and the second score for each of the at least one available frequency band supported by a wireless bridge device 110 may be calculated together at step S210.

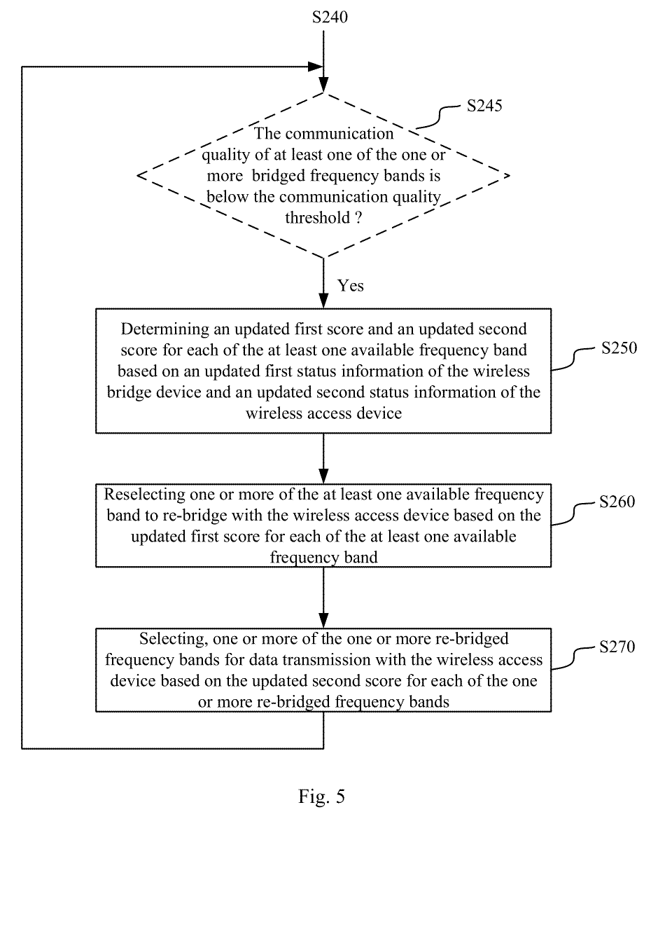

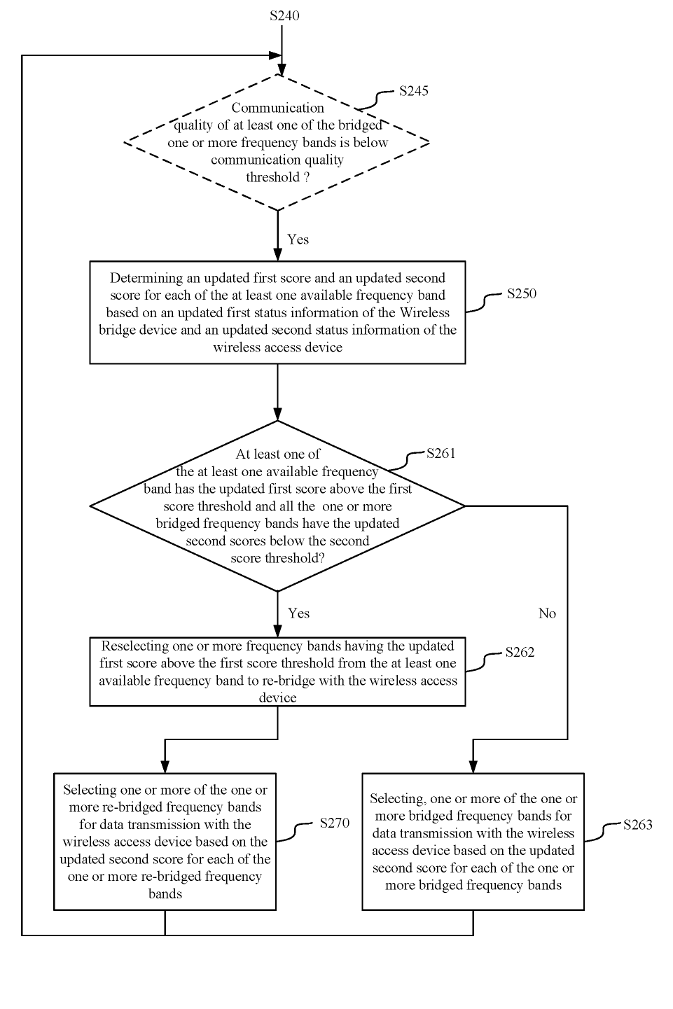

FIG. 5 is an exemplary flowchart illustrating the method for wireless bridging according to at least one embodiment of the present application.

After the wireless link(s) has been established, the communication quality of the bridged frequency band(s) may unexpectedly deteriorate due to interference, or the communication quality of the unbridged frequency band(s) may become better than the bridged frequency band(s). It is hoped that the wireless bridge device 110 may adaptively change the frequency band(s) to be bridged for efficient data transmission. To achieve this, with reference to FIG. 5, the method 200 for wireless bridging may further comprise steps S245 to S270.

At step S245, the wireless bridge device 110 may determine whether the communication quality of at least one of the one or more bridged frequency bands is below a communication quality threshold.

In an example, the interference strength and the updated channel utilization are crucial for the communication quality. The updated first status information comprises at least the updated interference strength or the updated channel utilization of the wireless bridge device 110. The wireless bridge device 110 may determine the communication quality of the one or more bridged frequency band to be below the communication quality threshold if the updated interference strength of the wireless bridge device is higher than the interference strength threshold or the updated channel utilization of the wireless bridge device is higher than the channel utilization threshold.

It should be noted that other parameter(s) may also be important to the communication quality and may be taken into account for the communication quality of the one or more bridged frequency bands.

If it is determined that the communication quality of at least one of the one or more bridged frequency bands is below the communication quality threshold, the method 200 proceeds to step S250. Otherwise, the step S245 is repeated.

At step S250, the wireless bridge device 110 may determine the updated first score and the updated second score for each of the at least one available frequency band based on the updated first status information of the wireless bridge device 110 and the updated second status information of the wireless access device 120.

The determination of the updated first score and an updated second score for each of the at least one available frequency band is similar to the determination of the first score and the second score for each of the at least one available frequency band described above and is therefore omitted here.

At step S260, the wireless bridge device 110 may reselect one or more of the at least one available frequency band to re-bridge with the wireless access device 120 based on the updated first score for each of the at least one available frequency band.

In this step, for any bridged frequency bands among the one or more bridged frequency bands that need to be disconnected from the wireless access device 120, the frequency band may be controlled to be disconnected from the wireless access device 120 after the completion of the ongoing data transmission thereon. This is advantageous to avoid the interruption of the data transmission.

At step S270, the wireless bridge device 110 may select one or more of the one or more re-bridged frequency bands for data transmission with the wireless access device 120 based on the updated second score for each of the one or more re-bridged frequency bands.

After the step S270, the method 200 may return back to step S245.

Thus, once the communication quality of current at least one bridged frequency band is become below the communication quality threshold, the wireless bridge device 110 may adaptively switch frequency bands to be bridged. In this way, even if the data transmission rate and reliability of the wireless bridge decline due to the interference, it may be automatically restored, thereby ensuring the reliability of the data transmission.

As a variant, the step S245 may be omitted and the method 200 may procced to the step S250 after the step S245. For example, the wireless bridge device 110 may periodically receive the updated second status information of the wireless access device 120, because the wireless access device 120 may periodically broadcast the real-time second status information to the wireless bridge device 110 by the broadcast frame. Therefore, the wireless bridge device 110 may determine the updated first score and the updated second score for each of the at least one available frequency band as long as it receives the broadcast frame sent by the wireless access device 120. In this variant, the method 200 may return back to step S250 after the step S270.

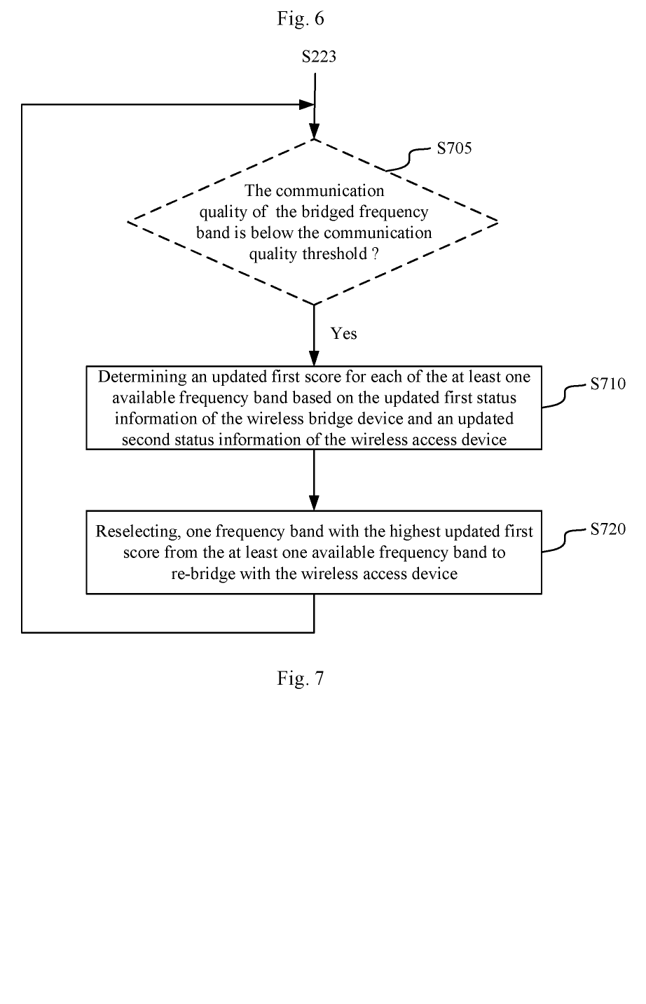

FIG. 6 is an exemplary flowchart illustrating the method for wireless bridging according to at least one embodiment of the present application.

Comparing FIG. 6 with FIG. 5, the step S260 may include the steps S261 and S263.

At the step S261, the wireless bridge device 110 may determine whether at least one of the at least one available frequency band supported by the wireless bridge device 110 has the updated first score above the first score threshold and all of the one or more bridged frequency bands have the updated second scores below the second score threshold.

If it is determined that the at least one of the at least one available frequency bands supported by the wireless bridge device 110 has the updated first score above the first score threshold and all of the one or more bridged frequency bands have the updated second scores below the second score threshold (the “Yes” branch), the method 200 may proceed to the step S262. Otherwise (the “No” branch), the method 200 may proceed to the step S263. The “No” branch means that either there is a frequency band having the updated second score higher than the second score threshold among the bridged frequency bands, and thus the re-bridge is not necessary, or that there is no frequency band having a first score higher than the first score threshold among all the available frequency bands supported by the wireless bridge device 110, and thus the effect of the data transmission will not get better even if the re-bridge is performed.

For example, continuing with the previous example where the wireless bridge device 110 has bridged with the wireless access device 120 over the frequency bands 2.4GHz, 5GHz, and 6GHz and has selected the 5GHz and 6GHz for data transmission with the wireless access device 120. Given that the updated first scores for the frequency bands 2.4GHz, 5GHz, and 6GHz is 0.3, 0.4 and 0.6, and for simplicity, the updated second scores for the frequency bands 2.4GHz, 5GHz, and 6GHz are determined to be the same as the updated first scores for the frequency bands 2.4GHz, 5GHz, the wireless bridge device 110 may determine that the bridged frequency band 6GHz has the updated first score (i.e., 0.6) above the first score threshold (i.e., 0.5) and all the updated second scores for bridged frequency bands 2.4GHz, 5GHz, and 6GHz are below the second score threshold (i.e., 0.7). The wireless bridge device 110 may then reselect the frequency band 6GHz to re-bridge with the wireless access device 120, as only the updated first score for the frequency band 6GHz is above the first score threshold.

For another example, continuing with the previous example where the wireless bridge device 110 has bridged with the wireless access device 120 over the frequency bands 2.4GHz, 5GHz, and 6GHz and has selected the 5GHz and 6GHz for data transmission with the wireless access device 120. Given that the updated first scores for the frequency bands 2.4GHz, 5GHz, and 6GHz are 0.2, 0.3 and 0.4, and for simplicity, the updated second scores for the frequency bands 2.4GHz, 5GHz, and 6GHz are determined to be the same as the updated first scores for the frequency bands 2.4GHz, 5GHz, the wireless bridge device 110 may determine that there is no frequency band with a first score higher than the first score threshold among all the available frequency bands supported by the wireless bridge device 110. The wireless bridge device 110 may then perform the step S263 to select one or more of the one or more currently bridged frequency bands 2.4GHz, 5GHz, and 6GHz for data transmission with the wireless access device based on the updated second score (i.e., 0.2, 0.3 and 0.4) for each of the one or more currently bridged frequency bands. In particular, the wireless bridge device 110 may reselect only the bridged frequency band 6GHz for data transmission, maintain the bridged frequency bands 5GHz and 6GHz for data transmission, or reselect all the three bridged frequency bands 2.4GHz, 5GHz, and 6GHz for data transmission, depending on the amount of data to be transmitted or received.

It should be noted that, in the variant described above where the step S245 is omitted, the method 200 may return back to step S250 after the step S263.

FIG. 7 is an exemplary flowchart illustrating the method for wireless bridging according to at least one embodiment of the present application.

As previously described with respect to FIG. 3, if it is determined in step S221 that the at least one of the wireless bridge device 110 and the wireless access device 120 does not support multi-frequency bands mode, the method 200 may proceed to step S223 to select one frequency band with the highest first score from the at least one available frequency band to bridge with the wireless access device 120.

Referring to FIG. 7, after step S223, the method 200 may further includes the steps S705 to S720.

At the step S705, the wireless bridge device 110 may determine whether the communication quality of the one bridged frequency band is below a communication quality threshold based on the updated first status information of the wireless bridge device 110.

Similar to the description with respect to the step S245, the wireless bridge device 110 may determine the communication quality of the one bridged frequency band to be below the communication quality threshold if the updated interference strength for the one bridged frequency band of the wireless bridge device 110 is higher than an interference strength threshold or the updated channel utilization for the one bridged frequency band of the wireless bridge device 110 is higher than a channel utilization threshold at the step S705.

If it is determined in the step S705 that the communication quality of the one bridged frequency band is below a communication quality threshold, the method may proceed to the step S710. Otherwise, the step S705 is repeated.

At the step S710, the wireless bridge device 110 may determine the updated first score for each of the at least one available frequency band based on the updated first status information of the wireless bridge device 110 and an updated second status information of the wireless access device 120.

It should be noted that most of the operations for the step S705 and the step S250 are similar, the details for the same operations are omitted herein for conciseness.

At step S720, the wireless bridge device 110 may reselect one frequency band with the highest updated first score from the at least one available frequency band 2.4GHz, 5GHz, and 6GHz to re-bridge with the wireless access device 120. Only one frequency band is re-bridged, the re-bridged frequency band of course being used for data transmission with the wireless access device 120.

In this step, the bridged frequency band on which the data transmission is in progress may be disconnected from the wireless access device 120 after the completion of the data transmission. This is advantageous to avoid the interruption of the data transmission.

After the step S720, the method 200 may also return back to step S705.

As a variant, the step S705 may be omitted and the method 200 may proceed to the step S710 after the step S223. For example, the wireless bridge device 110 may periodically receive the updated second status information of the wireless access device 120, because the wireless access device 120 may periodically broadcast the real-time second status information to the wireless bridge device 110 by the broadcast frame. Therefore, the wireless bridge device 110 may determine the updated first score and the updated second score for each of the at least one available frequency band as long as it receives the broadcast frame sent by the wireless access device 120. In this variant, the method 200 may return back to step S710 after the step S720.

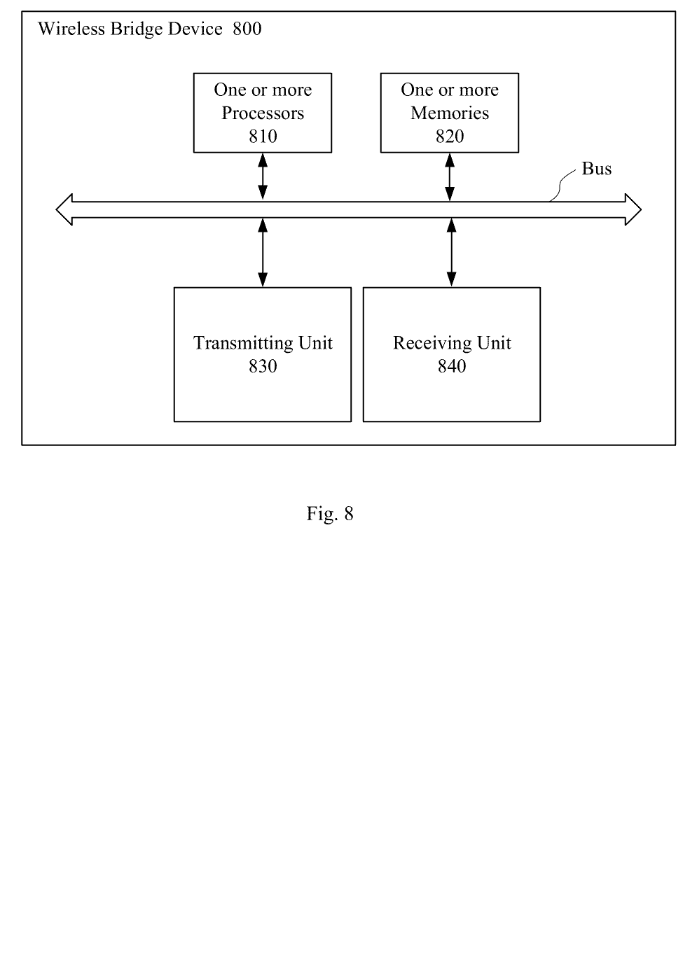

FIG. 8 is an exemplary block diagram illustrating a wireless bridge device according to at least one embodiment of the present application.

It should be noted that the wireless bridge device 800 depicted in FIG. 8 may correspond to the wireless bridge device 120 described above and may be used to perform the method 200 as described above.

As shown in FIG. 8, the wireless bridge device according to embodiments of the disclosure may comprise one or more processors 810, one or more memories 820, a transmitting unit 830 and a receiving unit 840. The one or more processors 810 may be coupled with the one or more memories 820 via a communication bus and may be configured to perform the method 200 discussed above. The transmitting unit 830 and the receiving unit 840 may perform the data transmission with the wireless access device 120.

Examples of processor 810 may comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout the present disclosure.

The one or more processors 810 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the one or more memories 820.

The one or more memories 820 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer.

In addition, according to another embodiment of the present disclosure, a computer program product for data transmission is disclosed. As an example, the computer program product includes a computer-readable medium having program instructions embodied therewith, and the program instructions are executable by a processor. When executed, the program instructions cause the processor to perform one or more procedures described above. The present disclosure may be a system, a method, and/or a computer program product at any possible technical detail level of integration. The computer program product may include a computer-readable storage medium having computer-readable program instructions thereon for causing a processor to carry out aspects of the present disclosure.

The present disclosure may be a system, a method, and/or a computer program product at any possible technical detail level of integration. The computer program product may include a computer-readable storage medium having computer-readable program instructions thereon for causing a processor to carry out aspects of the present disclosure.

An expression such as “according to”, “based on”, “dependent on”, and so on as used in the disclosure does not mean “according only to”, “based only on”, or “dependent only on” unless it is explicitly otherwise stated. In other words, such expression generally means “according at least to”, “based at least on”, or “dependent at least on” in the disclosure.

The term “determining” used in the disclosure may include various operations. For example, regarding “determining”, calculating, computing, processing, deriving, investigating, looking up (e.g., looking up in tables, databases, or other data structures), ascertaining, and so forth are regarded as "determination". In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth may also be regarded as “determining”. That is, regarding "determining", several actions may be regarded as “determining”.

The terms such as “connected”, “coupled” or any of their variants used in the disclosure refer to any connection or combination, direct or indirect, between two or more units, which may include the following situations: between two units that are “connected” or “coupled” with each other, there are one or more intermediate units. The coupling or connection between the units may be physical or logical, or may also be a combination of the two. As used in the disclosure, two units may be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure may be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for wireless bridging comprising:
determining, a first score for each of at least one available frequency band supported by a wireless bridge device based on a first status information of the wireless bridge device and a second status information of a wireless access device; and
selecting, one or more of the at least one available frequency band to bridge with the wireless access device based on a first capability information of the wireless bridge device, a second capability information of the wireless access device, and the first score for each of the at least one available frequency band.

2. The method of claim 1, wherein selecting one or more of the at least one available frequency band to bridge with the wireless access device, comprises:
selecting, one or more frequency bands having the first score above a first score threshold from the at least one available frequency band to bridge with the wireless access device, in response to the first capability information indicating that the wireless bridge device supports a multi-frequency bands mode and the second capability information indicating that the wireless access device supports the multi-frequency bands mode.

3. The method of claim 1, wherein selecting one or more of the at least one available frequency band to bridge with the wireless access device, comprises:
selecting, one frequency band having the highest first score from the at least one available frequency band to bridge with the wireless access device, in response to the first capability information indicating that the wireless bridge device does not support the multi-frequency bands mode and/or the second capability information indicating that the wireless access device does not support the multi-frequency bands mode.

4. The method of claim 2, further comprising:
determining, a second score for each of the one or more bridged frequency bands based on the first status information of the wireless bridge device and the second status information of a wireless access device; and
selecting, one or more of the one or more bridged frequency bands for data transmission with the wireless access device based on the second score for each of the one or more bridged frequency bands.

5. The method of claim 4, selecting one or more of the one or more bridged frequency bands for data transmission with the wireless access device, comprises:
selecting at least one bridged frequency band having the second score above a second score threshold from the one or more bridged frequency bands for data transmission with the wireless access device; or
selecting the top at least one of the one or more bridged frequency bands ranked in descending order of their second scores for data transmission with the wireless access device in case that none of the one or more bridged frequency bands has the second score above the second score threshold.

6. The method of claim 4, further comprising:
determining, an updated first score and an updated second score for each of the at least one available frequency band based on an updated first status information of the wireless bridge device and an updated second status information of the wireless access device;
reselecting one or more of the at least one available frequency band to re-bridge with the wireless access device based on the updated first score for each of the at least one available frequency band; and
selecting, one or more of the one or more re-bridged frequency bands for data transmission with the wireless access device based on the updated second score for each of the one or more re-bridged frequency bands.

7. The method of claim 6, wherein the reselecting one or more of the at least one available frequency band, comprising:
reselecting, one or more frequency bands having the updated first score above the first score threshold from the at least one available frequency band to re-bridge with the wireless access device in response to at least one of the at least one available frequency band having the updated first score above the first score threshold and all the one or more bridged frequency bands having the updated second scores below the second score threshold.

8. The method of claim 6, wherein the determining the updated first score and the updated second score for each of the at least one available frequency band, comprising:
determining the updated first score and the updated second score for each of the at least one available frequency band in response to a communication quality of at least one of the one or more bridged frequency bands being determined to be below a communication quality threshold based on the updated first status information of the wireless bridge device.

9. The method of claim 3, further comprising:
determining an updated first score for each of the at least one available frequency band based on the updated first status information of the wireless bridge device and an updated second status information of the wireless access device; and
reselecting, one frequency band with the highest updated first score from the at least one available frequency band to re-bridge with the wireless access device.

10. The method of claim 9, wherein the determining the updated first score for each of the at least one available frequency band, comprising:
determining the updated first score for each of the at least one available frequency band in response to a communication quality of the one bridged frequency band being determined to be below a communication quality threshold based on the updated first status information of the wireless bridge device.

11. The method of claim 6, wherein reselecting one or more of the at least one available frequency band to re-bridge with the wireless access device, comprises:
for any of the one or more bridged frequency band need to be disconnected with the wireless access device, disconnecting the frequency band after the ongoing data transmission thereon is completed.

12. The method of claim 4, wherein:
the first status information indicates at least one of the following parameters of the wireless bridge device: interference strength, channel utilization, signal strength, transmission rate, transmission delay and throughput; and
the second status information indicates at least one of the following parameters of the wireless access device: interference strength, channel utilization, signal strength, transmission rate, transmission delay and throughput.

13. The method of claim 12, wherein
for each of the at least one available frequency band, the second score of the frequency band is determined using a set of parameters for the first status information and the second status information different from that used to determine the first score of the frequency band.

14. The method of claim 5, wherein:
for each of the at least one available frequency band, the second score of the frequency band is determined to be the same as the first score of the frequency band; and
the second score threshold is higher than the first score threshold.

15. The method of claim 8, wherein
the updated first status information comprises at least an updated interference strength or an updated channel utilization of the wireless bridge device; and
the communication quality of the one or more bridged frequency bands is determined to be below the communication quality threshold when the updated interference strength of the wireless bridge device is higher than an interference strength threshold or the updated channel utilization of the wireless bridge device is higher than a channel utilization threshold.

16. The method of claim 1, wherein:
the first status information comprises at least the interference strength the wireless bridge device;
the second status information comprises at least the interference strength of the wireless access device; and
determining the first score for each of the at least one available frequency band based on the first status information and the second status information, comprises: for each of the at least one available frequency band, determining the first score of the frequency band as the minimum value of the value range of the first score in response to the interference strength of the wireless bridge device is higher than the interference strength threshold or the interference strength of the wireless access device is higher than the interference strength threshold.

17. The method of claim 1, wherein:
the first status information comprises at least the channel utilization of the wireless bridge device;
the second status information comprises at least the channel utilization of the wireless access device; and
determining the first score for each of the at least one available frequency band based on the first status information and the second status information, comprises: for each of the at least one available frequency band, determining the first score of the frequency band as the minimum value of the value range of the first score in response to the channel utilization of the wireless bridge device is higher than the channel utilization threshold or the channel utilization of the wireless access device is higher than the channel utilization threshold.

18. The method of claim 1, wherein:
the second capability information and the second status information are broadcast from the wireless access device to the wireless bridge device.

19. A wireless bridge device comprising:
one or more memories, storing computer readable instructions;
one or more processors, coupled with the one or more memories that, when the computer readable instructions executed by the one or more processors, cause the one or more processors to:
determine, a first score for each of at least one available frequency band supported by a wireless bridge device based on a first status information of the wireless bridge device and a second status information of a wireless access device; and
select, one or more of the at least one available frequency band to bridge with the wireless access device based on a first capability information of the wireless bridge device, a second capability information of the wireless access device, and the first score for each of the at least one available frequency band.

20. A wireless bridge system comprising:
a wireless bridge device, comprising:
one or more memories, storing computer readable instructions;
one or more processors, coupled with the one or more memories that, when the computer readable instructions executed by the one or more processors, cause the one or more processors to:
determine, a first score for each of at least one available frequency band supported by a wireless bridge device based on a first status information of the wireless bridge device and a second status information of a wireless access device; and
select, one or more of the at least one available frequency band to bridge with the wireless access device based on a first capability information of the wireless bridge device, a second capability information of the wireless access device, and the first score for each of the at least one available frequency band;
a wireless access device configured to broadcast the second capability information and the second status information to the wireless bridge device.
